(19) United States
(12) Patent Application Publication
(10) Pub. No.: US 2026/0244612 A1
(43) Pub. Date: Aug. 20, 2026

(54) ASSESSING DATA QUALITY IN CROWDSOURCED DATA AND OTHER USER-SUBMITTED DATA

(71) Applicant: Kennesaw State University Research And Service Foundation, Inc., Kennesaw, GA (US)

(72) Inventors: Kevin Gittner, Kennesaw, GA (US); Lauren Matheny, Kennesaw, GA (US)

(21) Appl. No.: 19/545,744

(22) Filed: Feb. 20, 2026

Related U.S. Application Data
(60) Provisional application No. 63/761,038, filed on Feb. 20, 2025.

(51) Int. Cl. G06F 16/23

(52) U.S. Cl. CPC G06F 16/2365

(57) ABSTRACT

The present disclosure provides methods for assessing reliability of user-submitted response data for an electronic test. Methods may include providing, by a computing system, an electronic test to a user device and receiving, by the computing system, response data corresponding to a plurality of prompts of the electronic test. The computing system may determine a plurality of validation signals associated with the response data. The computing system may determine, based on at least one of the plurality of validation signals, a composite quality score for the response data. The computing system may determine, based on the composite quality score, a risk classification for the response data. The computing system may perform, based on the risk classification, an enforcement action with respect to the response data.

### CROSS-REFERENCE TO RELATED APPLICATION

This application is a Nonprovisional of and claims the benefit of Provisional Application No. 63/761,038 filed February 20, 2026, which is hereby incorporated by reference in its entirety for any and all purposes.

### BACKGROUND

Data has become more valuable. For example, as artificial intelligence (AI) models become more prolific, data to train the AI models becomes more valuable. However, ad hoc data created specifically to be sold may have issues, such as being created by an AI system, a bot, a careless person, and/or a person outside a relevant demographic.

Improvements are needed.

### SUMMARY

The following summary is for illustrative purposes only, and is not intended to limit or constrain the detailed description.

The present disclosure provides methods for assessing reliability of user-submitted response data for an electronic test. Methods may include providing, by a computing system, an electronic test to a user device and receiving, by the computing system, response data corresponding to a plurality of prompts of the electronic test. The computing system may determine a plurality of validation signals associated with the response data. The computing system may determine, based on at least one of the plurality of validation signals, a composite quality score for the response data. The computing system may determine, based on the composite quality score, a risk classification for the response data. The computing system may perform, based on the risk classification, an enforcement action with respect to the response data.

The present disclosure provides methods for detecting unreliable or automated submissions using capability probes configured to elicit deficiencies indicative of automated generation or non-human processing limitations. Methods may include providing, by a computing system, an electronic test that includes at least one capability probe configured to elicit a deficiency indicative of automated generation or non-human processing limitations and receiving, by the computing system, response data to the electronic test. The computing system may determine whether the response data exhibits the deficiency. The computing system may generate, based at least in part on whether the deficiency is determined, a reliability indicator. The computing system may modify, based on the reliability indicator, a quality score associated with the response data.

The present disclosure provides methods for longitudinal assessment of reliability across multiple submissions associated with a respondent. Methods may include receiving, by a computing system, a plurality of submissions associated with a respondent, each submission comprising response data to an electronic test. The computing system may store, based on the plurality of submissions, one or more detection events in an evidence record associated with a respondent profile. The computing system may determine, based on a plurality of stored detection events from the evidence record, an aggregated reliability measure for the respondent profile. When the aggregated reliability measure satisfies an escalation criterion, the computing system may perform an enforcement action affecting at least one subsequent submission associated with the respondent profile.

These and other features and advantages are described in greater detail below.

### BRIEF DESCRIPTION OF THE DRAWINGS

The present disclosure is pointed out with particularity in the appended claims.

FIG. 1 shows an example environment according to the present disclosure.

FIG. 2 shows an example pipeline according to the present disclosure.

FIG. 3 shows an example graphical user interface according to the present disclosure.

FIG. 4 shows example methods according to the present disclosure.

FIG. 5 shows example methods according to the present disclosure.

FIG. 6 shows example methods according to the present disclosure.

The accompanying drawings show examples of the disclosure. It is to be understood that the examples shown in the drawings and/or discussed herein are non-exclusive and that there are other examples of how the disclosure may be practiced.

### DETAILED DESCRIPTION

The present disclosure generally relates to systems and methods for assessing data quality in user-submitted data. The user-submitted data may be collected in connection with crowdsourced studies, panel-based recruitment, open online recruitment, or other collection channels, including web-based platforms, mobile applications, messaging-based workflows, and educational or enterprise systems. In some implementations, the user-submitted data may be received from participants recruited via online advertisements, social media, email, text message, or other outreach mechanisms, and the user-submitted data may include responses to electronic tests, assignments, assessments, or other structured or semi-structured prompts.

Detection may operate as a flagging system that accumulates evidence over time. Rather than immediately rejecting a submission, the system may record one or more detected events (e.g., prompt injection detection, copy/paste events, suspicious behavioral telemetry) associated with an identity, device, account, or respondent profile. A pattern of repeated detections across multiple submissions may be used as a basis for escalating enforcement actions, generating reports, or triggering manual review.

The systems and methods described herein facilitate offering a standalone product that may be licensed to major companies providing online survey platforms, similar to how Imperium’s fraud detection algorithms are integrated into platforms like Qualtrics. The systems and methods described herein may alleviate the burden on the platforms, which do not specialize in large detection of responses generated or assisted by generative models or other automated mechanisms (e.g., text-generation models, multimodal models, agentic workflows, automation scripts, or bots), by providing the platforms with a robust, ready-to-integrate solution at various product levels to, for example, detect automated or model-assisted responses to electronic tests.

The systems and methods described herein may facilitate licensing a model-assisted or automated-response detection algorithm (or fraud detection algorithm) to large survey platforms. By integrating the systems and methods described herein into existing systems, the platforms may enhance data quality assurance capabilities without having to develop specialized LLM detection technology in-house. A model implementing the systems and methods described herein may mirror successful industry practices where companies like Qualtrics purchase third-party fraud detection algorithms (e.g., Imperium) to supplement service offerings. In addition to a standalone detection algorithm, the systems and methods described herein may be incorporated into advanced Hypertext Markup Language (HTML) randomization techniques, JavaScript, or other programming languages. Incorporating the systems and methods described herein into advanced HTML randomized techniques may provide an additional layer of security by making it more difficult for automated respondent systems (including scripts, bots, and model-assisted agents) to predict and adapt to test formats. Incorporating the systems and methods described herein into advanced HTML randomized techniques may be offered as an optional upgrade to the detection algorithm, available through a separate licensing agreement. A tiered approach may allow for catering to different levels of client needs and security concerns, providing both basic and advanced fraud detection solutions that may quickly adapt to new models being developed.

The reliability assessment system may be deployed as a standalone application that provides an embedded browser or embedded test interface. Such an application may capture additional signals not reliably available through standard browser-based scripts, subject to user permissions and consent and subject to platform capabilities and applicable policy constraints. For example, the application may obtain richer device-context and location indicators, and may capture additional environmental or proximity signals. In implementations where customers prefer not to require application installation, a browser-based deployment may alternatively rely on device and browser fingerprinting signals.

In educational settings (e.g., learning management systems), the disclosed techniques may be used to detect automated generation in assignments, discussion posts, or other submissions. Detection may be performed on a single submission and/or by accumulating evidence across multiple submissions over time. For example, repeated detections associated with an account or student profile may be recorded as a body of evidence to support escalation, review, or administrative workflows.

Passive in-survey telemetry may be captured across one or more pages or blocks. Example telemetry includes mouse movement tracking, scroll tracking, keystroke logging and timing analysis, mouse clicks, tab switching events, copy/paste events, and detection of browser developer tools (DevTools) status. These signals may be used independently or combined to classify an interaction as likely human, likely automated, or suspicious.

Copy/paste detection may include capturing paste events into one or more input fields, identifying pasted content characteristics (e.g., length, formatting, presence of hidden tokens), and correlating paste events with keystroke timing patterns. Copy/paste detections may be particularly indicative of an automated respondent system scraping content and inserting generated text, or a human using generative AI and pasting outputs into response fields.

Device and network metadata may be collected and used as validation signals. Example metadata includes browser navigator information, operating system, webdriver indicators, screen resolution, time zone, installed fonts, CPU cores, WebRTC information, audio context characteristics, language settings, and do-not-track/privacy indicators. Such signals may support digital fingerprinting, detection of automation frameworks, and identification of unusual device or environment patterns. Depending on platform constraints, one or more listed signals may be unavailable, substituted, or computed indirectly.

Network-based signals may include analyzing IP addresses for duplicates, comparing IP addresses to publicly available risk indicators or reputation data sources (e.g., deny lists, allow lists, anomaly feeds, or internally generated risk lists), and detecting suspicious VPN or masking behavior. Such signals may be used alone or as weighted inputs to a composite risk score.

An embedded location request (e.g., a JavaScript-based location request) may be compared to self-reported location information. A discrepancy between self-reported location and embedded location may be treated as an indicator of unreliability and may affect a quality score or risk tier classification.

The quality score may be computed using a weighting system in which different indicators contribute different weights based on correlation with fraud risk. Multiple lower-risk indicators may be aggregated to trigger flagging even where no single indicator is determinative. The weighting system may be configurable by a client to increase or decrease strictness.

Due to limitations in data capture through standard browser environments, a dedicated application with an embedded browser may be used. The application may capture richer signals than are reliably obtainable through HTML5/JavaScript alone, including additional network-related information, device context, and location signals, such as nearby or related IP signals and nearby wireless emitters detectable by the user device (e.g., Bluetooth Low Energy advertisement beacons and other broadcast identifiers), regardless of whether such emitters are actively paired or connected to the user device. For example, the application may capture broadcast identifiers and signal-presence patterns for nearby Bluetooth devices over time, which may support longitudinal consistency analysis and detection of anomalous changes indicative of spoofing, relocation, or automation-assisted participation.

Beyond licensing the systems and methods described herein to large survey platforms, validation datasets with known provenance, including datasets generated or assisted by generative AI systems and other automated mechanisms, may be offered to applied researchers, as well as customization services for specific clientele needs. The validation datasets may comprise responses generated by or with assistance from various generative models (including multimodal models) and/or automated workflows, and may include text outputs as well as non-text outputs or references to non-text inputs, depending on implementation. By providing a controlled environment with a known response pool, the datasets may help researchers validate their survey instruments, algorithms, and analytical techniques against model-assisted or automated content. The validation datasets may be particularly attractive to academic institutions, research organizations, and companies conducting large-scale survey research, adding another revenue stream for organizations not interested in long-term licenses. To further enhance the value of the systems and methods described herein, customization services may be offered where the fraud detection algorithm may be tailored to meet specific needs of individual clients. Customization service may include configuring an algorithm for different types of surveys, integrating the algorithm with proprietary systems, or adapting the algorithm for different languages or cultural contexts. Alongside customization, ongoing technical support may be provided to ensure smooth integration and operation within a client’s platforms. Providing ongoing technical support is a service-oriented component of the systems and methods described herein. Providing ongoing technical support may facilitate clients deriving value from the systems and methods described herein, fostering long-term partnerships, and customer loyalty.

The systems and methods described herein may cover other areas susceptible to automated or model-assisted fraud, such as online teaching and assessments, market research, customer feedback systems, etc. The systems and methods described herein offer a versatile solution across multiple domains.

Automated respondent systems may vary in sophistication. At a first level, rules-based bots may navigate web pages and insert nonsense or blanks. At higher levels, bots may scrape page content and paste it into fields, incorporate LLMs to generate coherent responses, and add behavioral variability. The most advanced systems may operate across sessions, maintain credentials, and function as computer-using agents with contextual recall across multiple interactions. Accordingly, layered validation signals and adaptable detection methods may be employed.

An automation framework may be used to validate and calibrate detection methods by generating controlled automated interactions. For example, an automation workflow may scrape a page, supply extracted content to a generative model, capture model output, and feed the output back into the automation process to drive interactions. Such a validation harness may support testing robustness of detection methods across platform themes and formatting variations.

The accompanying drawings, which form a part hereof, show examples of the disclosure. It is to be understood that the examples shown in the drawings and/or discussed herein are non-exclusive and that there are other examples of how the disclosure may be practiced.

It is to be understood that both the following general description and the following detailed description are exemplary and explanatory only and are not restrictive.

As used herein, an “automated respondent system” may include any system that automatically generates, selects, or supplies responses, including but not limited to a bot, automation script, browser automation workflow, agentic workflow, AI agent, or computer-using agent (CUA). An automated respondent system may include, for example, a rules-based script, a browser automation workflow, a bot configured to scrape prompt content and populate response fields, or a system that incorporates generative artificial intelligence (e.g., a large language model) to produce response text. An automated respondent system may operate using a single-stage process (e.g., selecting fixed response options or inserting predetermined text) or a multi-stage process (e.g., extracting displayed content, generating a response using a model, and returning the generated response to the interface). An automated respondent system may operate as an agentic workflow capable of navigating web interfaces, selecting options, generating free-text entries, and maintaining internal consistency across multiple questions within a session. An automated respondent system may further maintain state across sessions, such that responses provided in a later session may be influenced by stored context from an earlier session. Automated respondent systems may be configured to mimic characteristics of human interaction, including variable response timing, cursor movement, or other behavior patterns, and such characteristics may be considered when evaluating reliability of response data.

Quality checking for user-submitted response data may therefore involve evaluating response content in combination with signals associated with interaction behavior and execution environment. For example, attention-check prompts and basic validation rules may be used in conjunction with additional validation signals to determine reliability of response data when automated respondent systems are present. Such additional validation signals may include interaction-based signals derived from interaction telemetry collected during completion of the electronic test (e.g., copy/paste events, timing patterns, focus changes, tab switching), as well as device, browser-environment, or network metadata that may be indicative of automation frameworks or repeated submissions. Validation signals may also include outcomes of capability probes configured to elicit deficiencies indicative of automated generation or non-human processing limitations (e.g., inability to process non-text modalities, failure to satisfy instruction-following constraints, or inclusion of refusal language). These validation signals may be combined to compute a composite quality score and to determine a risk classification, which may in turn govern selection of an enforcement action with respect to response data. A validation signal may include signal-detection outputs derived from proximity or environmental sensing.

Configuration of scoring and enforcement operations may be application-dependent and client-dependent. In certain contexts, reliability criteria may be configured to emphasize strict screening, such as where higher confidence in respondent authenticity is desired. In other contexts, reliability criteria may be configured to reduce false positives, such as where diverse response styles or varying completion environments are expected. A weighting scheme applied to a plurality of validation signals may therefore be configurable, including configurable weights assigned to different signal categories, configurable thresholds used to map a composite quality score to a risk classification, and configurable enforcement actions selected in response to a risk classification. Configuration parameters may be specified via an administrative interface and may be stored to support reproducibility and audit. Configuration may also be updated over time based on stored detection events, manual review outcomes, or verification outcomes, such that the system may adapt scoring and enforcement decisions to observed patterns while maintaining consistent application of configured policies.

References to “LLM-generated” responses are exemplary and non-limiting. The disclosed systems may be applied to responses generated or assisted by generative AI systems (including text-only models and multimodal models) and may additionally be applied to responses influenced by non-text inputs or non-text outputs, including images, video, three-dimensional content, audio, sensor-derived data, or other modality representations (e.g., embeddings or feature vectors derived from such modalities). The disclosed systems may also be applied to responses associated with physical or device-derived signals (e.g., proximity sensing, motion sensing, environmental sensing, or wireless-signal observation) and to responses associated with user-identifying inputs when permitted (e.g., biometric indicators or other unique identifiers). Accordingly, the disclosed techniques are not limited to text-based collection or analysis and may be used with any combination of modality inputs, modality outputs, and collection environments.

A “validation signal” may include any measured or observed indicator associated with a user, device, browser environment, network environment, response content, or interaction behavior that correlates with reliability, authenticity, attentiveness, demographic consistency, or likelihood of automation. Validation signals may be combined to compute a quality score and/or risk tier classification.

As used herein, references to large language models (LLMs) are exemplary and non-limiting. The disclosed methods may be used to detect or assess reliability of responses that are generated, assisted, or supplied by generative artificial intelligence, automated scripts, bots, agentic workflows, or other computer-produced mechanisms, including computer-using agents that interact with user interfaces.

Assigning the quality score may comprise applying a weighting system or rule set to a plurality of validation signals to compute a composite score. The composite score may be mapped to a classification or risk tier (e.g., low, medium, high risk), and one or more enforcement actions may be taken based on the score or tier, including flagging, exclusion, additional verification, or routing to manual review. The weighting, thresholds, and enforcement actions may be configurable.

Determining reliability may include detecting one or more deficiencies indicative of automated generation or non-human processing limitations, such as failures to process an image, document, or video; tokenization or instruction-following failures; or detection of refusal outputs or prohibited-content guardrail notifications. Such deficiencies may be treated as validation signals that affect the quality score.

Determining reliability may be additionally based on passive behavioral signals captured during completion of the test, including but not limited to mouse movement, scrolling behavior, keystroke timing, tab switching, developer tools status, and copy/paste events.

A quality score may be computed by applying a weighting system or rule set to multiple validation signals. Different signals may contribute different weights based on their correlation with unreliable or automated submissions. Multiple low-confidence indicators may be aggregated to produce a higher-confidence classification even when no single indicator is determinative.

The system may provide configurable thresholds and enforcement actions. For example, a first threshold may trigger flagging, a second threshold may trigger additional verification, and a third threshold may trigger exclusion. A client may configure weights, thresholds, and actions to tune strictness, to balance false-positive and false-negative risk, and to adapt the system to different study types.

Reliability determinations may not be limited to a single submission. The system may store detected events (e.g., suspicious telemetry patterns, prompt-injection detection outcomes, copy/paste events, or repeated inconsistencies) associated with an identity, account, device fingerprint, or respondent profile. Over time, multiple detections may accumulate to form a body of evidence, which may be used to adjust scoring, escalate enforcement, generate reports, or trigger manual review.

This longitudinal approach may reduce the impact of one-off anomalies and may improve robustness against adaptive automated respondent systems that attempt to evade any single test.

Passive interaction telemetry may be captured during completion of the test. Example telemetry includes mouse movement patterns, scroll behavior, click locations and timing, focus changes, tab switching, dwell time per page, time between prompts, and keystroke timing patterns. Such telemetry may be used to distinguish human-like interaction from scripted or automated interaction.

Copy/paste detection may be implemented by capturing paste events into one or more input fields, measuring characteristics of pasted content (e.g., length, formatting, presence of anomalous characters), and correlating paste timing with keystroke patterns. Copy/paste detection may be indicative of a human pasting AI-generated text, a bot inserting generated content, or an automated workflow scraping prompts and inserting responses. Copy/paste signals may be used as direct indicators or as weighted inputs to the composite quality score.

The system may administer one or more prompts or tasks designed to elicit deficiencies that correlate with automated generation or non-human processing limitations. For example, the test may include content requiring interpretation of an image, document, or video, and a failure to meaningfully process such content may be treated as an indicator of unreliability.

The test may additionally include tasks designed to expose instruction-following or tokenization-related failures, such as character-counting, formatting constraints, or structured transformations. Further, the system may detect refusal outputs or prohibited-content guardrail notifications (e.g., standardized refusal language) and treat such outputs as indicators that an automated generation system was used or that the respondent is not answering based on the presented content. Any such deficiency may affect a quality score, risk tier, or enforcement decision.

Device and network metadata may be collected and used as validation signals. Example metadata includes browser and operating system characteristics, language and time zone settings, screen resolution, user agent properties, webdriver indicators, and other environment signals that may be used for fingerprinting or automation detection. Such signals may be used to identify repeated submissions from the same environment, detect suspicious clusters, and detect automation frameworks.

Network signals may include IP-based indicators such as duplicate IP submissions, VPN or masking indicators, geolocation inferred from IP address, and comparison of IP addresses to one or more risk indicators or reputation data sources (e.g., deny lists, allow lists, anomaly feeds, or internally generated risk lists). These signals may be used alone or as weighted inputs to a composite score.

An embedded location request may be compared to self-reported location information. A discrepancy between the self-reported location and embedded location may be treated as an indicator of unreliability, and may reduce a quality score or increase a risk tier. Location signals may be captured at various granularities, subject to permissions and consent, and may be used in combination with other telemetry and network signals.

Automated respondent systems may vary in sophistication. At a first level, a rules-based script may select options or insert predetermined text. At higher levels, automated systems may scrape displayed content and generate responses based on that content, including using generative AI. More advanced agentic workflows may navigate multiple pages, correct errors, and maintain internal consistency across multiple related questions (e.g., ensuring age and birth year align) within a session.

Computer-using agents may maintain contextual memory across sessions and interactions. Accordingly, layered validation signals and adaptable detection methods may be employed, including composite scoring, longitudinal evidence accumulation, and multiple independent families of indicators.

Controlled automation workflows may be used to validate, calibrate, or harden the disclosed detection mechanisms. For example, a controlled automation workflow may be used to generate labeled interactions representing known automation patterns. Outputs from such controlled interactions may be used to evaluate detection sensitivity, tune weights and thresholds, and assess robustness across platform variations. This use of controlled automation may support defensive testing and quality assurance for reliability assessment systems.

Additional verification may be performed after an initial submission and prior to providing incentives or other benefits. For example, a follow-up may be sent via email, text message, or another channel to confirm demographic or study-qualification information. Results of the delayed verification may be incorporated into the quality score, risk tier, or enforcement decision.

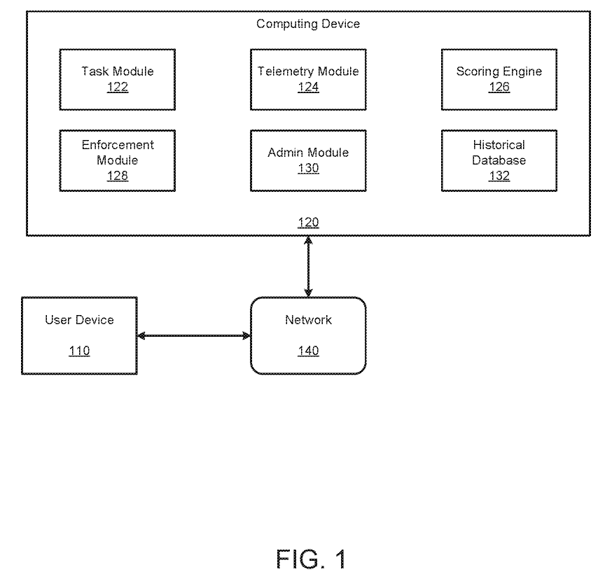

FIG. 1 illustrates a system that may be used to assess reliability of user-submitted data, including response data received in connection with an electronic test. The system may include a user device 110, a computing device 120, and a network 140 that may enable communications between the user device 110 and the computing device 120. The computing device 120 may include, implement, or otherwise access a task module 122, a telemetry module 124, a scoring engine 126, an enforcement module 128, an admin module 130, and a historical database 132. The system may be implemented using one or more physical machines, one or more virtual machines, or combinations thereof, and the computing device 120 may be implemented as a server system, a cloud platform, a distributed service, or a hybrid architecture. The components shown in FIG. 1 may be integrated within the computing device 120, or one or more components may be implemented as separate services that communicate via the network 140. The labels and reference numerals in FIG. 1 are provided to describe functional roles, and one or more functions described for one component may be performed by another component depending on implementation constraints.

The user device 110 may be a computing device used by a respondent to interact with an electronic test provided by the computing device 120. The user device 110 may include a browser, a standalone application, an embedded browser, or another interface that renders prompts and collects input associated with the electronic test. The user device 110 may present a plurality of prompts of the electronic test, including prompts that function as attention-check prompts, demographic-verification prompts, and logical-consistency prompts. The user device 110 may capture user inputs including selections, free-text responses, and interactions with interface elements, and the user device 110 may transmit such inputs as response data to the computing device 120. The user device 110 may also emit or allow collection of interaction telemetry during completion of the electronic test, such as keystroke timing, tab switching, mouse movement, scrolling, and copy/paste events. The user device 110 may permit, deny, or condition access to certain telemetry and device indicators based on permissions, privacy settings, and platform capabilities, and collection may be performed in a manner consistent with those constraints.

The computing device 120 may be a computing system that provides the electronic test to the user device 110 and receives response data from the user device 110. The computing device 120 may perform operations that include providing the electronic test, receiving response data corresponding to a plurality of prompts, determining validation signals, determining a composite quality score, determining a risk classification, and performing an enforcement action. The computing device 120 may be implemented as a single server, a server cluster, a set of microservices, or a cloud-based workload that scales based on volume of tests or respondents. The computing device 120 may host or access data stores, rule sets, scoring models, and administrative interfaces that enable configuration and review. The computing device 120 may orchestrate interactions among the task module 122, the telemetry module 124, the scoring engine 126, and the enforcement module 128, including sequencing of operations and management of intermediate outputs. The computing device 120 may also manage identity association and evidence tracking across multiple sessions and submissions, including generating or updating a respondent profile recorded in the historical database 132.

The task module 122 may generate, select, configure, or administer an electronic test that is provided to the user device 110. The task module 122 may construct the electronic test as a plurality of prompts, including prompts that function as attention-check prompts, demographic-verification prompts, and logical-consistency prompts. The task module 122 may control sequencing of prompts, randomization of prompt ordering, branching logic, and gating based on prior responses. The task module 122 may include or enable inclusion of non-visible instruction content or embedded content within a test page, including by use of markup, style content, and script content, and such content may be used to evaluate whether response data includes output responsive to non-visible instruction content. The task module 122 may also include capability probes configured to elicit deficiencies indicative of automated generation or non-human processing limitations, including tasks that require processing an image, document, or video, tasks that require satisfaction of tokenization-sensitive or instruction-following constraints, or tasks that may elicit refusal outputs. The task module 122 may transmit prompt content and associated configuration to the user device 110 via the network 140, and the task module 122 may receive response data to the prompts via the computing device 120.

A telemetry module 124 may collect, receive, derive, or normalize interaction telemetry and environment metadata associated with completion of the electronic test on the user device 110. The telemetry module 124 may capture passive interaction telemetry such as mouse movement patterns, scroll behavior, click locations and timing, focus changes, tab switching, dwell time per page, time between prompts, and keystroke timing patterns. The telemetry module 124 may detect copy/paste events into one or more input fields, may measure characteristics of pasted content, and may correlate paste timing with keystroke patterns to support classification of copy/paste behavior as a validation signal. The telemetry module 124 may also collect device and browser-environment metadata, including user agent properties, language and time zone settings, screen resolution, webdriver indicators, and other environment signals that may be used for fingerprinting or automation detection. The telemetry module 124 may package collected telemetry and metadata into one or more validation signals, and the telemetry module 124 may provide the validation signals to the scoring engine 126 for use in determining a composite quality score. The telemetry module 124 may apply filtering, sampling, or privacy-preserving transformations to telemetry prior to storage or scoring, and the telemetry module 124 may be configured to adhere to platform and permission constraints. As used herein, telemetry may include client-side interaction events and timing information captured during completion of a test, including at least one of keystroke timing, pointer movement, scrolling, focus changes, tab switching, or copy/paste events.

The scoring engine 126 may determine a plurality of validation signals associated with response data and may compute a composite quality score for the response data based on at least one of the plurality of validation signals. The scoring engine 126 may accept validation signals derived from content-based analysis of response data and validation signals derived from interaction telemetry collected during completion of the electronic test. The scoring engine 126 may apply a weighting scheme to the plurality of validation signals to determine the composite quality score, and the weighting scheme may be configurable to reflect different quality objectives. The scoring engine 126 may map the composite quality score to a risk classification, including a risk tier, and the scoring engine 126 may output the risk classification for downstream enforcement processing. The scoring engine 126 may incorporate deficiency-related signals, including failures to process non-text modalities, failures to satisfy tokenization-sensitive or instruction-following constraints, or inclusion of refusal language or prohibited-content handling indicators, and the scoring engine 126 may treat such deficiencies as validation signals that affect scoring. The scoring engine 126 may additionally generate intermediate outputs, such as per-signal sub-scores or diagnostic flags, that may be stored in the historical database 132 or presented via the admin module 130.

The enforcement module 128 may perform an enforcement action with respect to response data based on a risk classification determined by the scoring engine 126. The enforcement module 128 may select enforcement actions that include flagging response data, excluding response data, requesting additional verification, or routing response data for manual review. The enforcement module 128 may implement enforcement actions synchronously during the test (for example, gating progression or requesting additional steps) or asynchronously after receipt of response data (for example, exclusion from analysis or post-hoc review queues). The enforcement module 128 may cause a quality score to be lowered or may cause one or more responses to be removed based on detected conditions, including determinations that responses were completed using automated generation systems, completed by inattentive respondents, completed by respondents outside of a target demographic, or completed by copying and pasting text. The enforcement module 128 may initiate a follow-up verification workflow using the network 140, such as sending a follow-up message via email or text to confirm demographic or study-qualification information, and results may be incorporated into scoring and enforcement. The enforcement module 128 may also store enforcement outcomes and supporting rationales as detection events in the historical database 132 to support longitudinal tracking.

The admin module 130 may provide configuration, monitoring, and review functions for operation of the system. The admin module 130 may provide interfaces to define or adjust prompt sets used by the task module 122, including definition of attention-check prompts, demographic-verification prompts, and logical-consistency prompts, and may manage templates for different test configurations. The admin module 130 may allow configuration of scoring parameters used by the scoring engine 126, including weighting schemes, thresholds, mappings from composite scores to risk classifications, and escalation criteria for longitudinal enforcement. The admin module 130 may provide review dashboards that present flagged submissions, supporting validation signals, and detected deficiencies, and may support routing to manual review as an enforcement action. The admin module 130 may expose or control telemetry collection settings for the telemetry module 124, including enabling or disabling capture of particular telemetry types and defining retention policies, subject to platform capabilities. The admin module 130 may allow administrators to view aggregated analytics, including rates of flagged submissions by signal category, drift in telemetry baselines, and outcomes of follow-up verification workflows. The admin module 130 may also support export of reports or audit trails generated based on stored detection events in the historical database 132.

The historical database 132 may store response data, validation signals, composite quality scores, risk classifications, enforcement outcomes, and other records associated with operation of the system. The historical database 132 may store detection events in an evidence record associated with a respondent profile. The historical database 132 may support longitudinal analysis by enabling association of multiple submissions with a respondent, an account, a device, an identity, or other linking mechanism, and the historical database 132 may store such associations for later retrieval. The historical database 132 may store a plurality of stored detection events from the evidence record, enabling computation of an aggregated reliability measure for the respondent profile and evaluation of an escalation criterion for enforcement actions affecting subsequent submissions. The historical database 132 may store raw telemetry, derived telemetry features, or summarized telemetry indicators generated by the telemetry module 124, and storage may be configured to preserve only selected features or derived indicators. The historical database 132 may store outcomes of manual review and follow-up verification, and the historical database 132 may allow such outcomes to be incorporated into future scoring as additional validation signals or calibration inputs. The historical database 132 may also store administrative configuration states from the admin module 130 so that scoring decisions and enforcement outcomes may be reproduced or audited.

The network 140 may provide communications between the user device 110 and the computing device 120, and the network 140 may include one or more public networks, private networks, or combinations thereof. The network 140 may support transmission of test content, prompt content, scripts, and user interface elements from the computing device 120 to the user device 110, and the network 140 may support transmission of response data from the user device 110 to the computing device 120. The network 140 may also support transmission of telemetry data, metadata, and other validation-signal inputs collected during completion of the electronic test, subject to implementation constraints and permissions. The network 140 may provide network metadata that may itself be used as a validation signal, such as IP-based indicators, VPN or masking indicators, and geolocation inferred from IP address. The network 140 may be used to query or compare observed network attributes against lists of high-risk indicators, and results of such comparisons may be provided to the scoring engine 126 as part of a plurality of validation signals. The network 140 may also facilitate delivery of follow-up verification requests via channels such as email or text message when additional verification is requested as an enforcement action.

The computing device 120 may provide an electronic test generated by the task module 122 to the user device 110 over the network 140. The computing device 120 may receive response data entered via the user device 110 and transmitted via the network 140, where the plurality of prompts may be provided by the task module 122. The telemetry module 124 may determine interaction-based signals from interaction telemetry, and the scoring engine 126 may determine content-based signals derived from the response data, with outputs treated as validation signals. The scoring engine 126 may apply a weighting scheme to the plurality of validation signals. The scoring engine 126 may map the composite quality score to a risk classification and output the risk classification to downstream components. The enforcement module 128 may select and perform an enforcement action such as flagging response data, excluding response data, requesting additional verification, or routing response data for manual review, and records of such actions may be stored in the historical database 132 for longitudinal tracking and administration via the admin module 130.

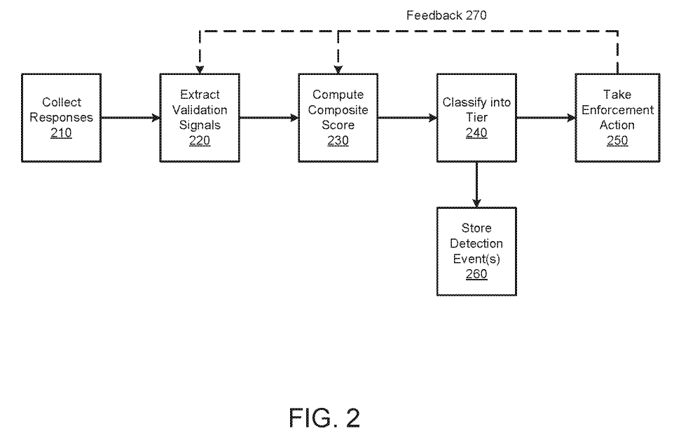

FIG. 2 illustrates a data-processing pipeline for assessing reliability of user-submitted data and for determining and acting on a quality assessment of response data. The pipeline may include a sequence of operations that may be implemented by the computing device 120 and its associated modules shown in FIG. 1, including the task module 122, the telemetry module 124, the scoring engine 126, and the enforcement module 128. The pipeline may include collecting responses 210, extracting validation signals 220, computing a composite score 230, classifying into tier 240, taking an enforcement action 250, storing detection event(s) 260, and providing feedback 270. The pipeline may be performed for a single submission or repeated for a plurality of submissions, and outputs of the pipeline may be stored for later aggregation and escalation using an evidence record associated with a respondent profile. Operations of the pipeline may be executed in real time during completion of an electronic test, after completion of the electronic test, or in a hybrid manner. The ordering shown in FIG. 2 is illustrative of functional flow, and one or more operations may be combined, subdivided, reordered, or iterated depending on implementation goals, performance constraints, or policy settings.

Collecting responses 210 may include receiving, by a computing system, response data corresponding to prompts of an electronic test provided to a user device. The collect responses 210 operation may include receiving selections, text entries, uploads, or other user-provided inputs that constitute response data to one or more prompts administered by the task module 122. The collect responses 210 operation may include associating the response data with metadata such as timestamps, page identifiers, prompt identifiers, session identifiers, or device identifiers, and such metadata may later support validation and longitudinal association. The collect responses 210 operation may include receiving partial responses, intermediate responses, or incremental updates while a respondent progresses through the electronic test, and such incremental updates may support real-time evaluation or gating. The collect responses 210 operation may include receiving response data from a browser-based interface or from a standalone application that renders an embedded browser or embedded test interface. The collect responses 210 operation may include receiving, as part of the response data, open-ended response elements that may be evaluated for characteristics indicative of reliability or unreliability. The collect responses 210 operation may also include receiving auxiliary data that is transmitted alongside responses, such as identifiers or context required to evaluate demographic-verification prompts or logical-consistency prompts.

Extracting validation signals 220 may include obtaining, deriving, or determining a plurality of validation signals associated with the response data. The extract validation signals 220 operation may include deriving content-based signals from the response data, including signals based on consistency with attention-check prompts, demographic-verification prompts, and logical-consistency prompts. The extract validation signals 220 operation may include deriving interaction-based signals from interaction telemetry collected during completion of the electronic test, including timing information, copy/paste events, focus changes, tab switching, scrolling behavior, or other interface interactions. The extract validation signals 220 operation may include obtaining device, browser-environment, and network metadata that may be used as validation signals, including IP-derived indicators or automation indicators, where such metadata is available and permitted. The extract validation signals 220 operation may include determining whether response data exhibits one or more deficiencies indicative of automated generation or non-human processing limitations, such as failure to process non-text modalities or other capability probes. The extract validation signals 220 operation may normalize raw observations into a common representation, may apply filtering or privacy-preserving transformations, and may compute derived features suitable for downstream scoring. The extract validation signals 220 operation may output the plurality of validation signals to the scoring engine 126 for score computation, and the extract validation signals 220 operation may also provide selected validation signals to an administrative interface for review.

Computing composite score 230 may include determining, by a computing system, a composite quality score for the response data based on at least one of the plurality of validation signals. The compute composite score 230 operation may apply a weighting scheme to the plurality of validation signals, and the weighting scheme may be configured to assign different weights to different signal categories based on their correlation with unreliability or automation. The compute composite score 230 operation may incorporate both content-based signals and interaction-based signals, and the compute composite score 230 operation may also incorporate device or network signals when such signals are available. The compute composite score 230 operation may include computing intermediate sub-scores for categories of signals (for example, content consistency, behavioral interaction, device/network environment), and the compute composite score 230 operation may combine such sub-scores into the composite quality score. The compute composite score 230 operation may support configurable parameters, such as threshold values, weight values, or rule sets, and such parameters may be set via an administrative module and may vary across clients or studies. The compute composite score 230 operation may generate diagnostic outputs that explain which validation signals contributed to the composite quality score, and such outputs may support audit, review, or later calibration. The compute composite score 230 operation may produce a numeric score, an ordinal score, a categorical score, or combinations thereof, and the compute composite score 230 operation may store the resulting score for use in longitudinal evidence accumulation.

Classifying into tier 240 may include determining, based on the composite quality score, a risk classification for the response data. The classify into tier 240 operation may map the composite quality score into one of a plurality of tiers, such as low-risk, medium-risk, or high-risk classifications, and tier definitions may be configurable. The classify into tier 240 operation may apply threshold comparisons or decision rules that convert a numeric composite quality score to a tier, and the decision rules may incorporate both the magnitude of the score and the presence of particular high-confidence signals. The classify into tier 240 operation may incorporate escalation criteria that consider prior detection events stored for a respondent profile, such that the tier assigned to a current submission may be affected by longitudinal evidence. The classify into tier 240 operation may also provide an override pathway in which a manual review outcome or administrative setting adjusts the tier assigned to a submission. The classify into tier 240 operation may generate a risk classification output that is consumed by an enforcement module to select an enforcement action. The classify into tier 240 operation may record the assigned tier and the basis for the assignment as part of the record stored for the submission, supporting traceability and later review.

Taking enforcement action 250 may include performing, based on the risk classification, an enforcement action with respect to the response data. The take enforcement action 250 operation may include flagging the response data, excluding the response data, requesting additional verification, or routing the response data for manual review. The take enforcement action 250 operation may be performed during completion of the electronic test, for example by gating further prompts, requesting additional tasks, or preventing submission, and the take enforcement action 250 operation may alternatively be performed after submission as a post-processing action. The take enforcement action 250 operation may include lowering a quality score or removing one or more responses when conditions indicative of unreliable submissions are detected, including conditions associated with automated generation, inattentiveness, out-of-demographic participation, or copying and pasting content. The take enforcement action 250 operation may include initiating delayed verification, such as sending a follow-up message via email or text to confirm demographic or qualification information, and results may later be incorporated into scoring and classification. The take enforcement action 250 operation may record the selected enforcement action and its rationale so that downstream stakeholders may understand outcomes and so that future calibration may be performed. The take enforcement action 250 operation may also trigger creation of detection events that are stored in an evidence record for longitudinal tracking.

Storing detection event(s) 260 may include storing one or more detection events in an evidence record associated with a respondent profile. The store detection event(s) 260 operation may store detection events that correspond to validation signals, composite scores, tier classifications, enforcement actions, and specific deficiency determinations, and the stored events may include timestamps and contextual metadata. The store detection event(s) 260 operation may store events at varying granularity, including storing raw telemetry indicators, derived signal summaries, or categorical flags, depending on storage constraints and privacy requirements. The store detection event(s) 260 operation may associate stored detection events with identifiers such as account identifiers, device fingerprints, browser-environment metadata, or network metadata, enabling later aggregation across submissions that are linked to the same respondent profile. The store detection event(s) 260 operation may facilitate computation of aggregated reliability measures and evaluation of escalation criteria for enforcement actions affecting subsequent submissions. The store detection event(s) 260 operation may support audit and reproducibility by enabling retrieval of the set of validation signals and parameters that produced a given score or enforcement action. The store detection event(s) 260 operation may also support training or calibration of scoring parameters by providing historical labeled outcomes, such as manual review results or verification outcomes, that may be incorporated into future scoring.

The feedback 270 operation may include using stored detection events, review outcomes, verification outcomes, or calibration results to adjust operation of one or more earlier stages of the pipeline. The feedback 270 operation may include adjusting the weighting scheme used to compute the composite quality score, adjusting thresholds used for tier classification, or adjusting enforcement rules used to select enforcement actions. The feedback 270 operation may be based on manual review decisions, follow-up verification results, observed false positives, observed false negatives, or drift in baseline interaction telemetry patterns over time. The feedback 270 operation may include updating configurations of prompts administered in the electronic test, including adding, removing, or modifying attention-check prompts, demographic-verification prompts, logical-consistency prompts, or capability probes, to improve detection coverage. The feedback 270 operation may include updating signal extraction logic, such as changing how telemetry events are converted into validation signals, changing how copy/paste events are interpreted, or changing how device/network indicators are normalized. The feedback 270 operation may be applied globally for a client configuration or selectively for a cohort, study, or respondent profile, and the feedback 270 operation may be recorded for auditability. The feedback 270 operation may also include updating a respondent profile or evidence record used for longitudinal escalation so that future submissions associated with the profile are subject to increased scrutiny or additional verification based on accumulated detections.

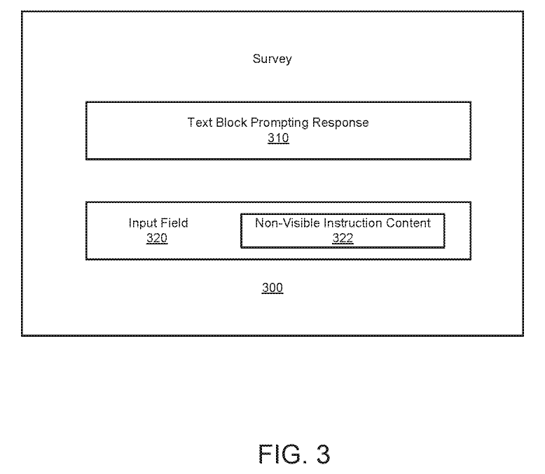

FIG. 3 illustrates a graphical user interface comprising a survey 300 that may be presented on a user device, where the survey 300 may include a text block prompting response 310, an input field 320, and non-visible instruction content 322. The survey interface 300 may be used as part of an electronic test administered by a computing system to a user device. The text block prompting response 310 may be presented visually to the respondent, while the non-visible instruction content 322 may be included in page content that is not visually presented to the respondent. The input field 320 may receive response data entered by the respondent and may transmit such response data to the computing system for determination of validation signals and scoring operations. The elements shown in FIG. 3 may be implemented in web content rendered by a browser, in content rendered by an embedded browser within a standalone application, or in another interface that supports display of prompts and collection of responses. The arrangement shown in FIG. 3 is provided to illustrate functional relationships among visible prompt content, response entry, and non-visible instruction content that may be used to obtain validation signals associated with response data.

A survey 300 may be an interactive user interface through which an electronic test is presented and response data is collected from a respondent. The survey 300 may be provided by a computing system to a user device over a network, and the survey 300 may be rendered by a browser, a standalone application, or an embedded browser interface. The survey 300 may include one or more pages that each contain one or more prompts, including prompts that function as attention-check prompts, demographic-verification prompts, and logical-consistency prompts. The survey 300 may include free-text prompts, multiple-choice prompts, or other prompt formats, and the survey 300 may collect corresponding response data as selections or text entries. The survey 300 may include logic that sequences prompts based on prior responses, and the survey 300 may include randomized ordering or branching to reduce predictability of prompt placement. The survey 300 may support collection of interaction-related signals by enabling capture of response timing, focus changes, or other interaction events while the respondent completes prompts presented in the survey 300. The survey 300 may transmit collected response data and associated context to a computing system that determines validation signals and determines a composite quality score and risk classification based on those validation signals.

A text block prompting response 310 may be a visible prompt presented within the survey 300 to elicit response data from the respondent. The text block prompting response 310 may correspond to a prompt of the electronic test, and the text block prompting response 310 may be one of a plurality of prompts administered during completion of the electronic test. The text block prompting response 310 may present a question, instruction, scenario, or task that the respondent may answer by entering text in the input field 320 or by otherwise providing response data. The text block prompting response 310 may be configured to function as an attention-check prompt, a demographic-verification prompt, or a logical-consistency prompt, and the text block prompting response 310 may also be configured to elicit an open-ended response element. The text block prompting response 310 may be formatted using markup and styling, and the text block prompting response 310 may include constraints or formatting instructions for responses, such as length limits, required keywords, or structured formatting requirements. The text block prompting response 310 may be associated with an identifier, a timestamp, and a page context such that response data received in the input field 320 may be linked to the text block prompting response 310 for content-based validation signal extraction. The text block prompting response 310 may be used in conjunction with other prompts in the survey 300 to permit evaluation of cross-question consistency, including consistency between demographic responses and other contextual answers.

An input field 320 may be an interactive control within the survey 300 through which a respondent supplies response data responsive to the text block prompting response 310. The input field 320 may include a text box, a multi-line text area, a structured input region, or another response-entry mechanism, and the input field 320 may accept free-text or other content as permitted by the survey 300. The input field 320 may transmit response data to a computing system when a respondent submits a page, selects a submit control, or otherwise completes a prompt, and the response data transmitted from the input field 320 may be the response data. The input field 320 may also provide interaction telemetry associated with response entry, including keystroke timing, cursor focus events, paste events, and editing behavior, and such interaction telemetry may be used to determine interaction-based validation signals. The input field 320 may be configured to detect copy/paste events and to record characteristics of pasted content, and such information may support identifying copying and pasting content as a condition affecting a quality score or enforcement action. The input field 320 may enforce constraints such as minimum length, maximum length, required formatting, or prohibited content, and constraint satisfaction or constraint violations may be used as content-based validation signals. The input field 320 may additionally support delayed submission or intermediate saving, and intermediate states of the input field 320 may be captured to support scoring, review, or audit of response-generation behavior.

Non-visible instruction content 322 may be instruction content included in the survey 300 that is not visually presented to a human respondent but may be accessible to an automated respondent system that processes page content. The non-visible instruction content 322 may be embedded within markup content, style content, script content, metadata, or other non-visible portions of a page that renders the text block prompting response 310 and/or the input field 320. The non-visible instruction content 322 may be configured to elicit a detectable output when an automated respondent system generates response data based on page content, including by causing the response data to include an indicator token, phrase, formatting pattern, or other output responsive to the non-visible instruction content 322. The non-visible instruction content 322 may be treated as a capability probe, and the presence of output responsive to the non-visible instruction content 322 may be used as a validation signal or as a deficiency indicator that modifies a quality score or triggers an enforcement action.

The non-visible instruction content 322 may be configured to be difficult for a human respondent to perceive through ordinary visual interaction with the survey 300, while remaining present in the page content that may be scraped or processed by automated systems. The non-visible instruction content 322 may be paired with expected outcome criteria such that the scoring engine may evaluate whether the response data includes an output responsive to the non-visible instruction content 322, and such evaluation may be performed as part of extracting validation signals and computing a composite quality score. The non-visible instruction content 322 may be updated, randomized, or rotated across surveys or across prompts to reduce predictability and to support feedback-driven refinement of detection coverage, consistent with the feedback mechanism described for the pipeline that stores detection events and applies feedback to adjust detection operations. Although shown as embedded in the input field 320, the non-visible instruction content 322 may be embedded in the text block prompting response 310 or elsewhere in the survey 300.

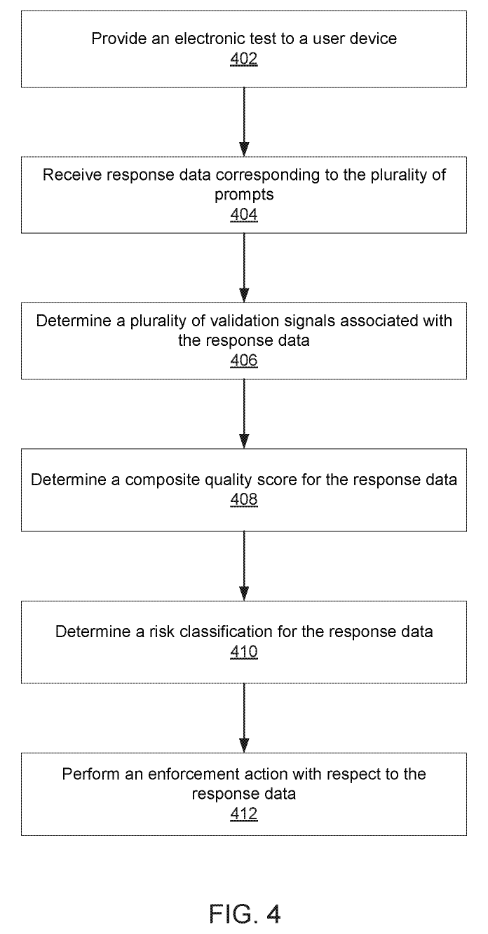

FIG. 4 shows a flow diagram showing example methods according to the present disclosure. The methods shown in FIG. 4 may be performed, for example, by the computing device 120 described above. The flow may represent a sequence of computer-implemented operations executed by a computing system that administers an electronic test, receives response data, derives validation signals, computes a composite quality score, classifies the response data based on the composite quality score, and performs an enforcement action with respect to the response data. The operations may be implemented as software-executable instructions stored on a non-transitory computer-readable medium and executed by one or more processors of a centralized server system, or may be implemented as distributed services (e.g., microservices) that communicate over one or more networks. The computing system may coordinate operations across one or more functional modules, including a task module that provides test content, a telemetry module that captures interaction telemetry, a scoring engine that computes a composite quality score, and an enforcement module that applies one or more actions based on a risk classification. Although FIG. 4 illustrates one representative flow, other implementations may vary in the ordering, concurrency, or partitioning of operations without departing from the scope of the present disclosure, including implementations in which certain operations are performed during completion of the electronic test and other operations are performed after completion.

An electronic test may be provided to user device (block 402). The electronic test may be provided by the computing system to a user device, and the electronic test may include a plurality of prompts such that the computing system may later receive response data corresponding to the plurality of prompts. The providing the test may include transmitting markup, script, style content, configuration data, and prompt content over a network for rendering by a browser or an embedded test interface on the user device.

The plurality of prompts may include at least one attention-check prompt, which may be configured to verify whether a respondent is reading and responding to presented content (e.g., an instruction to select a specified response option or to enter a specified keyword). The plurality of prompts may include at least one demographic-verification prompt, which may be configured to obtain or verify demographic information that may be compared to a target demographic or to other responses for consistency (e.g., age, location, education level, or professional role). The plurality of prompts may include at least one logical-consistency prompt, which may be configured to test internal coherence across responses (e.g., consistency between a stated age and a stated birth year, consistency between a stated location and a location-dependent answer, or consistency between earlier and later descriptions of the same fact).

The providing the test may further include providing an open-ended prompt that elicits a free-text response element, and the open-ended prompt may be configured to support content-based analysis such as duplication detection, template artifacts, or unnatural formatting patterns. The providing the test may also include including non-visible instruction content in a test page (e.g., content embedded in markup, style content, or script content that is not visually presented), where the presence of output responsive to the non-visible instruction content may later be used as a validation signal or deficiency indicator for automated respondent detection, consistent with non-visible instruction content described with respect to FIG. 3.

Response data corresponding to the plurality of prompts may be received (block 404). The response data may be received by the computing system from the user device. The receiving the response data may include receiving one or more discrete submissions for individual prompts, receiving a page-level submission that contains multiple prompt answers, or receiving incremental updates as a respondent progresses through the test. The response data may include structured responses (e.g., multiple-choice selections, numerical entries, date entries) and unstructured responses (e.g., free-text narrative), and the response data may include auxiliary metadata such as timestamps, prompt identifiers, session identifiers, or client-side event markers.

The receiving the response data may include receiving response data entered through an input field of a survey interface, where the input field may support interactions such as typing, editing, deleting, and copy/paste actions that may later be captured as interaction telemetry. The receiving the response data may include receiving responses that satisfy required constraints (e.g., minimum length requirements) as well as responses that violate constraints (e.g., missing required fields), and such constraint satisfaction or violations may later be used as content-based validation signals. The receiving the response data may include receiving, for a demographic-verification prompt, a respondent-provided demographic value, and the respondent-provided demographic value may later be compared to other demographic or environment signals (e.g., location inferred from network metadata) to determine consistency. The receiving the response data may also include associating the response data with a respondent profile, session profile, device identifier, or other linking mechanism so that later scoring and enforcement may be applied consistently across multiple submissions.

A plurality of validation signals associated with the response data may be determined (block 406). The plurality of validation signals may be determined by the computing system. The plurality of validation signals may include at least one content-based signal derived from the response data, and the content-based signal may include indicators derived from attention-check correctness, demographic-verification consistency, logical-consistency coherence, duplication or similarity across responses, presence of implausible content, or presence of characteristic artifacts (e.g., repeated phrasing patterns, boilerplate templates, or unnatural punctuation). The plurality of validation signals may include at least one interaction-based signal derived from interaction telemetry collected during completion of the electronic test, and the interaction telemetry may include keystroke timing, dwell time per prompt, cursor focus events, tab switching, mouse movement, scrolling behavior, or copy/paste events detected at the user device. The interaction telemetry or the plurality of validation signals may comprise proximity or environmental-sensing data collected by an application executing on the user device, the proximity or environmental-sensing data including detection of nearby wireless emitters that broadcast identifiers without pairing to the user device.

The determining the plurality of validation signals may include deriving telemetry features from raw event streams (e.g., computing typing burst patterns, paste-event frequency, edit distance between intermediate and final text, or time-to-first-keystroke) and normalizing such features for comparison against baseline expectations. The determining the plurality of validation signals may include deriving device, browser-environment, or network metadata signals (e.g., IP-based indicators, time zone mismatches, automation indicators, or other environment characteristics), and such signals may be used as additional validation signals when available and permissible. The determining the plurality of validation signals may include detecting deficiencies indicative of automated generation or non-human processing limitations, including detecting failure to follow an instruction constraint, detecting refusal language indicative of prohibited-content handling, or detecting output responsive to non-visible instruction content, and such deficiencies may be represented as validation signals or as high-weight flags. The determining the plurality of validation signals may include storing, in memory, a per-submission set of signals and values (e.g., a signal vector) and associated provenance such as which prompt or which telemetry source generated the signal, to support later review and audit.

A composite quality score for the response data may be determined (block 408). The composite quality score may be determined by the computing system for the response data and may be determined based on at least one of the plurality of validation signals. The determining the composite quality score may include applying a weighting scheme to the plurality of validation signals, and the weighting scheme may assign different weights to different signal types based on a configured policy, observed risk, or empirical correlation with unreliability. The weighting scheme may be implemented as a rules engine, a statistical model, a machine-learned classifier, or a hybrid that combines explicit rules with learned weights, and the weighting scheme may produce a numeric output and optionally a set of intermediate sub-scores (e.g., a content-consistency sub-score and an interaction-behavior sub-score). The determining the composite quality score may include incorporating a penalty for incorrect attention-check responses, incorporating a penalty for demographic inconsistencies (e.g., conflicting age ranges), and incorporating a penalty for logical inconsistencies across responses.

The determining the composite quality score may include applying a higher weight to signals indicative of automation (e.g., paste-event patterns inconsistent with human typing or outputs responsive to non-visible instruction content) relative to lower-confidence signals (e.g., minor timing anomalies), and the weights may be tuned to reduce false positives while maintaining detection sensitivity. The determining the composite quality score may include applying client-specific configuration to adjust strictness, including increasing weighting for high-stakes studies or reducing weighting for contexts where high variance in response behavior is expected. The determining the composite quality score may include outputting, along with the numeric score, an explanation record identifying which validation signals materially contributed to the score, and the explanation record may be used for manual review or later calibration.

A risk classification for the response data may be determined (block 410). The risk classification may be determined by the computing system based on the composite quality score. The risk classification may be determined by mapping a numeric score to one of a plurality of tiers (e.g., low-risk, medium-risk, high-risk), and threshold values defining the tiers may be configurable via administrative settings. The determining the risk classification may include applying a rule that elevates a tier when a high-confidence signal is present (e.g., a detected deficiency indicating non-human processing limitations or a strong automation indicator), even when the numeric score is otherwise near a boundary.

The determining the risk classification may include incorporating prior history from an evidence record associated with a respondent profile, such that repeated detection events may increase the risk classification for subsequent submissions, consistent with longitudinal evidence accumulation. The determining the risk classification may include assigning a classification to a submission and also assigning a classification to a respondent profile, where the profile classification may influence enforcement actions for future submissions. The determining the risk classification may include selecting or generating an output that is consumed by an enforcement module, where the output may include the tier, the score, and one or more trigger flags identifying signals that exceeded thresholds. The determining the risk classification may also include recording the basis for the classification (e.g., thresholds applied, weights used, and contributing signals) for traceability and later review.

An enforcement action may be performed with respect to the response data (block 412). The enforcement action may be performed by the computing system with respect to the response data based on the risk classification. The enforcement action may comprise at least one of flagging the response data, excluding the response data, requesting additional verification, or routing the response data for manual review. The performing the enforcement action may include flagging the response data for downstream analytics exclusion while retaining the response data for audit and training, and the flagging may include storing associated signals and rationale for later administrator inspection. The performing the enforcement action may include excluding the response data from a dataset used for decision-making, statistical analysis, or customer deliverables, and exclusion may be automatic when the risk classification exceeds a threshold.

The performing the enforcement action may include requesting additional verification, including initiating a delayed verification workflow (e.g., generating an email or text-based follow-up to confirm demographic or qualification information) and incorporating results into a subsequent scoring cycle or evidence record. The performing the enforcement action may include routing the response data for manual review, where a reviewer may view supporting validation signals (e.g., copy/paste detections, inconsistency flags, or deficiency determinations) and record an outcome that may be stored for audit and used to update scoring parameters through a feedback mechanism. The performing the enforcement action may also include applying adaptive enforcement rules for subsequent prompts, such as requiring additional prompts for high-risk submissions, introducing additional attention checks, or presenting different prompt types to increase confidence in reliability, while maintaining the ability to complete the electronic test when risk is acceptable.

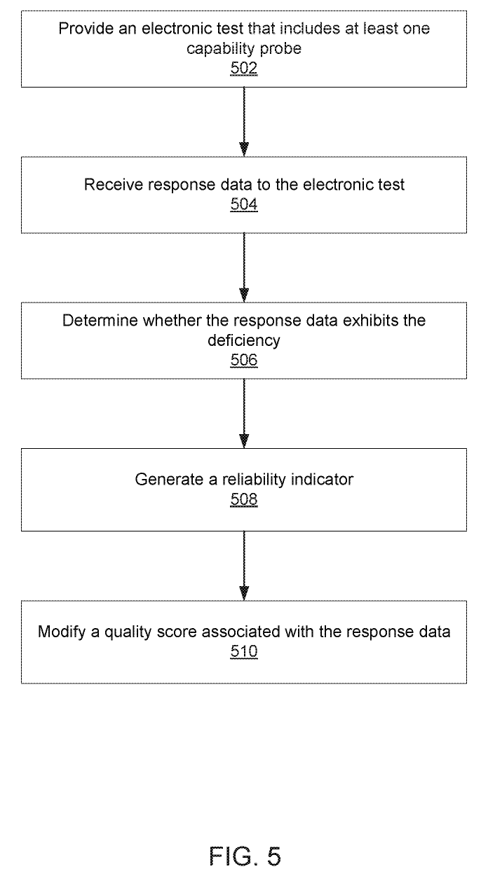

FIG. 5 shows a flow diagram showing example methods according to the present disclosure. The methods shown in FIG. 5 may be performed, for example, by the computing device 120 described above. The flow may represent a sequence of computer-implemented operations executed by a computing system configured to administer an electronic test that includes at least one capability probe, receive response data, evaluate whether the response data exhibits a deficiency indicative of automated generation or non-human processing limitations, generate a reliability indicator, and modify a quality score associated with the response data. The operations may be implemented as software-executable instructions stored on a non-transitory computer-readable medium and executed by one or more processors of a centralized server system, or may be implemented as distributed services that communicate over one or more networks. The computing system may coordinate operations across one or more functional modules, including a task module that provides test content (including capability probes), a scoring engine that evaluates expected outcomes and generates indicators, and an enforcement module that may implement threshold-based actions. Although FIG. 5 illustrates one representative flow, other implementations may vary in the ordering, concurrency, or partitioning of operations without departing from the scope of the present disclosure, including implementations in which certain operations are performed during completion of the electronic test and other operations are performed after completion.

An electronic test that includes at least one capability probe may be provided (block 502). The electronic test may be provided by a computing system. The at least one capability probe may be configured to elicit a deficiency indicative of automated generation or non-human processing limitations. The providing the capability-probe test may include transmitting, to a user device, page content, prompt content, media content, and configuration data that define at least one capability probe and that enable collection of response data for subsequent evaluation. The at least one capability probe may include content presented in a non-text modality, including an image, a document, or a video, such that failure to process or accurately describe the presented content may constitute the deficiency.

The at least one capability probe may include a tokenization-sensitive or instruction-following constraint (e.g., a constraint specifying a character count, required formatting tokens, a structured transformation, or a required ordering of specific terms) such that failure to satisfy the constraint may constitute the deficiency. The at least one capability probe may be configured to elicit inclusion of refusal language or a guardrail-notification output indicating prohibited-content handling, such that inclusion of such output may constitute the deficiency. The providing the capability-probe test may include providing non-visible instruction content embedded in markup, style content, or script content of a test page that is not visually presented to a human respondent, such that output responsive to the non-visible instruction content may be used to determine whether the deficiency is exhibited, consistent with the non-visible instruction content 322 described with respect to FIG. 3. The providing the capability-probe test may further include configuring expected capability outcomes for the capability probe (e.g., a correct description of an image, a required formatting pattern, or an expected absence of refusal language), and the expected capability outcomes may be stored for later evaluation.

Response data to the electronic test may be received (block 504). The response data may be received by the computing system and may include response data to the electronic test that includes the at least one capability probe. The receiving the response data may include receiving free-text responses, structured responses, uploaded content, or other response modalities depending on the capability probe and the interface used to present the probe. The response data may include responses to prompts that request the respondent to describe an image, summarize a document, identify details in a video, or perform a structured transformation of provided content. The response data may include response text entered into an input field and may include interaction indicators such as timestamps, focus events, or paste events, which may be stored as associated context for later analysis even when the primary deficiency evaluation is content-based.

The receiving the response data may include receiving intermediate submissions or incremental updates during completion of the electronic test, such that deficiency evaluation may be performed in near-real time. The receiving the response data may include receiving responses that contain phrases or patterns indicative of refusal or prohibited-content handling, and such phrases or patterns may be preserved as part of the response data for subsequent determination of whether the deficiency is exhibited. The receiving the response data may include associating the response data with identifiers such as a prompt identifier, a session identifier, or a respondent profile identifier so that outcomes of deficiency evaluation may be stored and used for subsequent scoring or enforcement.

A determination may be made as to whether the response data exhibits the deficiency (block 506). The computing system may make the determination of whether the response data exhibits the deficiency indicative of automated generation or non-human processing limitations. The determining whether the response data exhibits the deficiency may include evaluating the response data against an expected capability outcome for the capability probe, where the expected capability outcome may define one or more acceptable response criteria. The evaluating may include comparing response text to expected content features (e.g., whether the response mentions key image elements, whether the response includes a required structured output, or whether the response satisfies a required character count within a tolerance).

The evaluating may include detecting failure to process or accurately describe content presented in a non-text modality, including an image, document, or video, such as by identifying responses that are generic, non-responsive, internally inconsistent with the presented content, or otherwise inconsistent with expected content anchors for the probe. The evaluating may include detecting failure to satisfy a tokenization-sensitive or instruction-following constraint, such as a constraint requiring that a response include an exact number of characters, that a response include specific delimiters, or that a response transform a provided string into a specified normalized format, where failure to satisfy the constraint may be represented as the deficiency.

The evaluating may include detecting inclusion of refusal language or a guardrail-notification output indicating prohibited-content handling, including standardized refusal phrases, disclaimers, or policy statements that are inconsistent with ordinary human completion of the electronic test, and such detected phrases may be represented as the deficiency. The determining whether the response data exhibits the deficiency may also include determining that the response data includes an output responsive to non-visible instruction content embedded in markup, style content, or script content, such as a response that includes a predetermined token or phrase that was not visually presented to a human respondent.

A reliability indicator may be generated (block 508). The reliability indicator may be generated by the computing system based at least in part on whether the deficiency is determined. The reliability indicator may be generated as a binary flag, a categorical classification, a probability score, or a multi-level risk indicator, and the reliability indicator may be stored in association with the response data and the capability probe that produced the indicator. The reliability indicator may reflect a degree to which the response data is consistent with expected capability outcomes for the capability probe, and the reliability indicator may incorporate additional context such as whether multiple deficiencies were detected across multiple probes within the electronic test. The reliability indicator may incorporate weighting that assigns higher significance to certain deficiency categories, such as a refusal output indicative of prohibited-content handling or an output responsive to non- visible instruction content, relative to less determinative deficiencies such as minor formatting deviations, while preserving non-limiting configurability.

The reliability indicator may be generated together with an explanation record that identifies which deficiency condition triggered the indicator, such as a “media processing failure” label, an “instruction constraint failure” label, or a “refusal output detected” label, and the explanation record may be used to support review or audit. The reliability indicator may be generated in real time to allow gating actions during completion of the electronic test, or the reliability indicator may be generated after submission for batch scoring. The reliability indicator may be associated with a respondent profile such that repeated deficiency detections across multiple sessions may contribute to longitudinal reliability assessment.

A quality score associated with the response data may be modified (block 510). The quality score may be modified by the computing system based on the reliability indicator. The modifying the quality score may include lowering a quality score associated with the response data when the reliability indicator indicates that the deficiency was determined, and the modifying may include maintaining or increasing the quality score when the reliability indicator indicates that the deficiency was not determined. The modifying the quality score may include combining the reliability indicator with other validation signals, such as attention-check correctness, demographic consistency, logical consistency, interaction-based signals derived from interaction telemetry, or device/network indicators, to compute an updated quality score in a scoring engine.

The modifying the quality score may include applying a penalty amount that depends on deficiency type, such that an output responsive to non-visible instruction content or a refusal output may result in a larger penalty than a minor tokenization-sensitive formatting error, while permitting configuration of penalty values via administrative settings. The method may further include comparing the quality score to a threshold, where the threshold may define a minimum acceptable score for inclusion, acceptance, or reduced scrutiny. The method may further include performing, in response to the quality score not satisfying the threshold, an enforcement action with respect to the response data, where the enforcement action may include flagging the response data, excluding the response data, requesting additional verification, or routing the response data for manual review in a manner consistent with enforcement actions described elsewhere in the specification. The modifying the quality score may include storing the modified quality score and the associated reliability indicator as a detection event in an evidence record for later aggregation and escalation, including to affect scoring or enforcement decisions for subsequent submissions associated with a respondent profile.

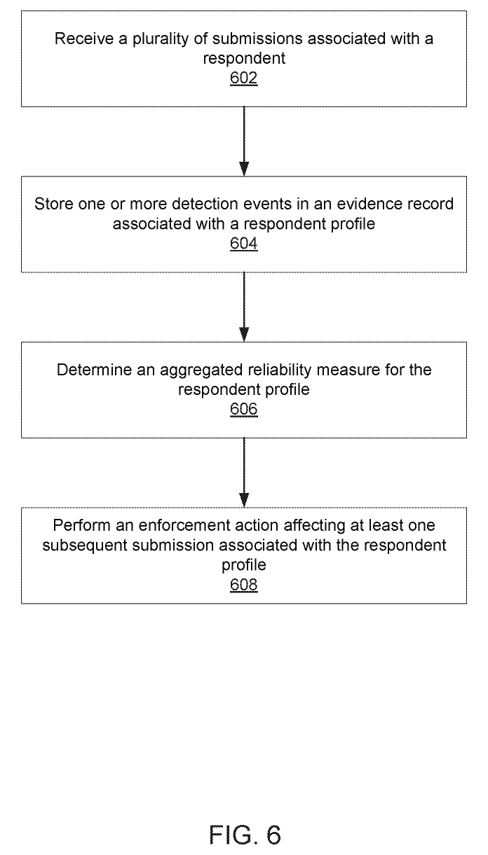

FIG. 6 shows a flow diagram showing example methods according to the present disclosure. The methods shown in FIG. 6 may be performed, for example, by the computing device 120 described above. The flow may represent a sequence of computer-implemented operations executed by a computing system configured to receive multiple submissions over time, maintain an evidence record associated with a respondent profile, determine an aggregated reliability measure based on stored detection events, and perform an enforcement action that affects at least one subsequent submission associated with the respondent profile. The operations may be implemented as software-executable instructions stored on a non-transitory computer-readable medium and executed by one or more processors of a centralized server system, or may be implemented as distributed services that communicate over one or more networks. The computing system may coordinate operations across one or more functional modules, including a telemetry module that obtains interaction telemetry and environment metadata, a scoring engine that computes per-submission scores and aggregated measures, an enforcement module that applies escalation actions, and a historical database that stores an evidence record and respondent profile data. The flow may be performed continuously as new submissions arrive, and the flow may support incremental updates to aggregated reliability measures such that enforcement actions may be triggered based on newly stored detection events. Although FIG. 6 illustrates one representative flow, other implementations may vary in ordering, concurrency, or partitioning of operations without departing from the scope of the present disclosure, including implementations in which aggregated reliability measures are updated on a scheduled basis, in a streaming manner, or in response to discrete submission events.

A plurality of submissions associated with a respondent may be received (block 602). The plurality of submissions may be received by a computing system, and each submission may comprise response data to an electronic test. The plurality of submissions may be associated with the respondent based on one or more linkage identifiers that permit grouping of submissions over time. Associating the plurality of submissions with a respondent profile may comprise associating the plurality of submissions based on at least one of device metadata, browser-environment metadata, a device fingerprint, an account identifier, network metadata, or an Internet Protocol (IP) address.

The receiving the plurality of submissions may include receiving submissions from multiple user devices used by the same respondent, including when the respondent uses different devices across different sessions, and the linkage identifiers may be used to maintain continuity across such sessions. The receiving the plurality of submissions may include receiving submissions that occur at different times, at different geographic locations, or using different network characteristics, and such context may be preserved as part of submission metadata to support later detection-event determination. The receiving the plurality of submissions may include receiving a submission that is partially completed, reattempted, or repeated, and such patterns may be used as contextual signals for subsequent reliability analysis. The receiving the plurality of submissions may include receiving response data that is generated by a human respondent, assisted by automated tools, or supplied by an automated respondent system, and the received submissions may be processed uniformly through subsequent operations to determine detection events and aggregated reliability.

One or more detection events may be stored in an evidence record associated with a respondent profile (block 604). The storing may be performed based on the plurality of submissions, and the evidence record may be maintained for the respondent profile based on the association established using linkage identifiers. The storing may comprise, for each respective submission of the plurality of submissions, collecting at least one validation signal associated with the respective submission, determining one or more associated detection events based on the at least one validation signal, and storing the one or more associated detection events in the evidence record. The at least one validation signal may include at least one of interaction telemetry, device or browser-environment metadata, network metadata, or a content-based signal derived from the response data, and the collecting may include receiving raw event streams and computing derived features (e.g., typing cadence metrics, paste-event frequency, or focus-change counts).

The determining one or more associated detection events may include generating categorical events (e.g., “copy/paste detected,” “attention-check failure,” “demographic mismatch,” “location discrepancy,” “automation indicator present”) and may include storing severity values, timestamps, and provenance identifying which prompt or telemetry source produced the event. The storing may include persisting detection events and associated validation-signal summaries in a historical database, and the storing may include retaining sufficient context to support later audit or manual review while permitting data minimization or retention policies. The evidence record may be updated incrementally as each new submission is processed, and the evidence record may support both per-submission actions and cross-submission aggregation for longitudinal escalation.

An aggregated reliability measure may be determined for the respondent profile (block 606). The aggregated reliability measure may be determined by the computing system for the respondent profile based on a plurality of stored detection events from the evidence record. The aggregated reliability measure may be computed as a numeric score, an ordinal ranking, a categorical tier, or a probability-like measure representing likelihood that submissions associated with the respondent profile are reliable. The determining the aggregated reliability measure may include applying a weighting scheme across detection events, where different event types may contribute differently to the aggregated reliability measure (e.g., repeated automation indicators may contribute more than isolated timing anomalies), and the weighting may be configurable through administrative settings.

The determining the aggregated reliability measure may include applying temporal logic, such as discounting older events, emphasizing recent events, or requiring a minimum number of events within a window to affect the aggregated reliability measure. The determining the aggregated reliability measure may include aggregating events across multiple devices or networks associated with the respondent profile, and the aggregation may incorporate confidence values associated with linkage identifiers to avoid incorrectly merging unrelated respondents. The determining the aggregated reliability measure may include incorporating outcomes of manual review or additional verification as stored detection events, and those outcomes may adjust the aggregated reliability measure to reflect confirmed reliability or confirmed unreliability. The determining the aggregated reliability measure may include generating an explanation record that identifies which stored detection events materially contributed to the aggregated reliability measure, and the explanation record may be used to support audit or review workflows.

An enforcement action affecting at least one subsequent submission associated with the respondent profile may be performed (block 608). The enforcement action may be performed by the computing system affecting at least one subsequent submission associated with the respondent profile when the aggregated reliability measure satisfies an escalation criterion. The escalation criterion may be expressed as a threshold on the aggregated reliability measure, a rule requiring a count of particular detection events, a rule based on event severity values, or a combination thereof, and the escalation criterion may be configurable. The enforcement action may comprise at least one of increasing scrutiny, requiring additional verification, excluding submissions, or routing submissions for manual review.

Increasing scrutiny may include modifying the electronic test for subsequent submissions by adding prompts, adding attention checks, adding capability probes, or increasing the frequency of telemetry capture, while permitting completion of the electronic test when reliability is acceptable. Requiring additional verification may include initiating a follow-up verification workflow for subsequent submissions, such as sending a verification request to confirm demographic or qualification information and recording outcomes as new detection events. Excluding submissions may include automatically excluding one or more subsequent submissions from analysis, reporting, incentive eligibility, or downstream processing when the aggregated reliability measure indicates unreliability at or above a threshold. Routing submissions for manual review may include placing subsequent submissions in a review queue and presenting associated detection events and validation-signal summaries to a reviewer, where a reviewer decision may be stored and may update the evidence record and aggregated reliability measure for future submissions.

### EXAMPLE CLAUSES

Example Clause 1: A method comprising: providing, by a computing system, an electronic test to a user device; receiving, by the computing system, response data corresponding to a plurality of prompts; determining, by the computing system, a plurality of validation signals associated with the response data; determining, by the computing system and based on at least one of the plurality of validation signals, a composite quality score for the response data; determining, by the computing system and based on the composite quality score, a risk classification for the response data; and performing, by the computing system and based on the risk classification, an enforcement action with respect to the response data.

Example Clause 2: The method of Example Clause 1, wherein the electronic test comprises the plurality of prompts.

Example Clause 3: The method of Example Clause 1 or Example Clause 2, wherein the plurality of prompts comprises at least one attention-check prompt.

Example Clause 4: The method of any one of Example Clauses 1-3, wherein the plurality of prompts comprises at least one demographic-verification prompt.

Example Clause 5: The method of any one of Example Clauses 1-4, wherein the plurality of prompts comprises at least one logical-consistency prompt.

Example Clause 6: The method of any one of Example Clauses 1-5, wherein the plurality of validation signals includes at least one content-based signal derived from the response data.

Example Clause 7: The method of any one of Example Clauses 1-6, wherein the plurality of validation signals includes at least one interaction-based signal derived from interaction telemetry collected during completion of the electronic test.

Example Clause 8: The method of any one of Example Clauses 1-7, wherein the interaction telemetry or the plurality of validation signals further comprises proximity or environmental-sensing data collected by an application executing on the user device, the proximity or environmental-sensing data including detection of nearby wireless emitters that broadcast identifiers without pairing to the user device.

Example Clause 9: The method of any one of Example Clauses 1-8, wherein the determining the composite quality score for the response data comprises applying a weighting scheme to the plurality of validation signals.

Example Clause 10: The method of any one of Example Clauses 1-9, wherein the enforcement action comprises at least one of flagging the response data, excluding the response data, requesting additional verification, or routing the response data for manual review.

Example Clause 11: A method comprising: providing, by a computing system, an electronic test that includes at least one capability probe configured to elicit a deficiency indicative of automated generation or non-human processing limitations; receiving, by the computing system, response data to the electronic test; determining, by the computing system, whether the response data exhibits the deficiency; generating, by the computing system and based at least in part on whether the deficiency is determined, a reliability indicator; and modifying, by the computing system and based on the reliability indicator, a quality score associated with the response data.

Example Clause 12: The method of Example Clause 11, wherein the deficiency comprises at least one of: failure to process or accurately describe content presented in a non-text modality including an image, document, or video; failure to satisfy a tokenization-sensitive or instruction-following constraint specified by the capability probe; or inclusion of refusal language or a guardrail-notification output indicating prohibited-content handling.

Example Clause 13: The method of Example Clause 11 or Example Clause 12, wherein the determining whether the response data exhibits the deficiency comprises evaluating the response data against an expected capability outcome for the capability probe.

Example Clause 14: The method of any one of Example Clauses 11-13, further comprising comparing the quality score to a threshold.

Example Clause 15: The method of any one of Example Clauses 11-14, further comprising performing, in response to the quality score not satisfying the threshold, an enforcement action with respect to the response data.

Example Clause 16: The method of any one of Example Clauses 11-15, wherein the at least one capability probe comprises non-visible instruction content embedded in at least one of markup, style content, or script content of a test page that is not visually presented to a human respondent, and wherein determining whether the response data exhibits the deficiency comprises determining that the response data includes an output responsive to the non-visible instruction content.

Example Clause 17: A method comprising: receiving, by a computing system, a plurality of submissions associated with a respondent, each submission comprising response data to an electronic test; storing, by the computing system and based on the plurality of submissions, one or more detection events in an evidence record associated with a respondent profile; determining, by the computing system and based on a plurality of stored detection events from the evidence record, an aggregated reliability measure for the respondent profile; and when the aggregated reliability measure satisfies an escalation criterion, performing, by the computing system, an enforcement action affecting at least one subsequent submission associated with the respondent profile.

Example Clause 18: The method of Example Clause 17, wherein the storing the one or more detection events in the evidence record associated with the respondent profile comprises, for each respective submission of the plurality of submissions: collecting, by the computing system, at least one validation signal associated with the respective submission; determining, by the computing system and based on the at least one validation signal, one or more associated detection events; and storing, by the computing system and based on the plurality of submissions, the one or more associated detection events in the evidence record associated with the respondent profile.

Example Clause 19: The method of Example Clause 17 or Example Clause 18, wherein the at least one validation signal includes at least one of interaction telemetry, device or browser-environment metadata, network metadata, or a content-based signal derived from the response data.

Example Clause 20: The method of any one of Example Clauses 17-19, wherein the enforcement action comprises at least one of increasing scrutiny, requiring additional verification, excluding submissions, or routing submissions for manual review.

Example Clause 21: The method of any one of Example Clauses 17-20, wherein associating the plurality of submissions with the respondent profile comprises associating the plurality of submissions based on at least one of device metadata, browser-environment metadata, a device fingerprint, an account identifier, network metadata, or an Internet Protocol (IP) address, and wherein the evidence record is maintained for the respondent profile based on the association.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
providing, by a computing system, an electronic test to a user device;
receiving, by the computing system, response data corresponding to a plurality of prompts;
determining, by the computing system, a plurality of validation signals associated with the response data;
determining, by the computing system and based on at least one of the plurality of validation signals, a composite quality score for the response data;
determining, by the computing system and based on the composite quality score, a risk classification for the response data; and
performing, by the computing system and based on the risk classification, an enforcement action with respect to the response data.

2. The method of claim 1, wherein the electronic test comprises the plurality of prompts.

3. The method of claim 2, wherein the plurality of prompts comprises at least one attention-check prompt.

4. The method of claim 2, wherein the plurality of prompts comprises at least one demographic-verification prompt.

5. The method of claim 2, wherein the plurality of prompts comprises at least one logical-consistency prompt.

6. The method of claim 1, wherein the plurality of validation signals includes at least one content-based signal derived from the response data.

7. The method of claim 6, wherein the plurality of validation signals includes at least one interaction-based signal derived from interaction telemetry collected during completion of the electronic test.

8. The method of claim 7, wherein the interaction telemetry or the plurality of validation signals further comprises proximity or environmental-sensing data collected by an application executing on the user device, the proximity or environmental-sensing data including detection of nearby wireless emitters that broadcast identifiers without pairing to the user device.

9. The method of claim 1, wherein the determining the composite quality score for the response data comprises applying a weighting scheme to the plurality of validation signals.

10. The method of claim 1, wherein the enforcement action comprises at least one of flagging the response data, excluding the response data, requesting additional verification, or routing the response data for manual review.

11. A method comprising:
providing, by a computing system, an electronic test that includes at least one capability probe configured to elicit a deficiency indicative of automated generation or non-human processing limitations;
receiving, by the computing system, response data to the electronic test;
determining, by the computing system, whether the response data exhibits the deficiency;
generating, by the computing system and based at least in part on whether the deficiency is determined, a reliability indicator; and
modifying, by the computing system and based on the reliability indicator, a quality score associated with the response data.

12. The method of claim 11, wherein the deficiency comprises at least one of: failure to process or accurately describe content presented in a non-text modality including an image, document, or video; failure to satisfy a tokenization-sensitive or instruction-following constraint specified by the capability probe; or inclusion of refusal language or a guardrail-notification output indicating prohibited-content handling.

13. The method of claim 11, wherein the determining whether the response data exhibits the deficiency comprises evaluating the response data against an expected capability outcome for the capability probe.

14. The method of claim 11, further comprising comparing the quality score to a threshold.

15. The method of claim 14, further comprising performing, in response to the quality score not satisfying the threshold, an enforcement action with respect to the response data.

16. The method of claim 11, wherein the at least one capability probe comprises non-visible instruction content embedded in at least one of markup, style content, or script content of a test page that is not visually presented to a human respondent, and wherein determining whether the response data exhibits the deficiency comprises determining that the response data includes an output responsive to the non-visible instruction content.

17. A method comprising:
receiving, by a computing system, a plurality of submissions associated with a respondent, each submission comprising response data to an electronic test;
storing, by the computing system and based on the plurality of submissions, one or more detection events in an evidence record associated with a respondent profile;
determining, by the computing system and based on a plurality of stored detection events from the evidence record, an aggregated reliability measure for the respondent profile; and
when the aggregated reliability measure satisfies an escalation criterion, performing, by the computing system, an enforcement action affecting at least one subsequent submission associated with the respondent profile.

18. The method of claim 17, wherein the storing the one or more detection events in the evidence record associated with the respondent profile comprises, for each respective submission of the plurality of submissions:
collecting, by the computing system, at least one validation signal associated with the respective submission;
determining, by the computing system and based on the at least one validation signal, one or more associated detection events; and
storing, by the computing system and based on the plurality of submissions, the one or more associated detection events in the evidence record associated with the respondent profile.

19. The method of claim 18, wherein the at least one validation signal includes at least one of interaction telemetry, device or browser-environment metadata, network metadata, or a content-based signal derived from the response data.

20. The method of claim 17, wherein the enforcement action comprises at least one of increasing scrutiny, requiring additional verification, excluding submissions, or routing submissions for manual review.
